(19) United States
(12) Patent Application Publication
(10) Pub. No.: US 2010/0125661 A1
(43) Pub. Date: May 20, 2010

(54) ARRANGEMENT FOR MONITORING PERFORMANCE OF NETWORK CONNECTION

(75) Inventors: Pekka PERALA, Oulu (FI); Mikko HANSKI, Oulu (FI); Marko JURVANSUU, Oulu (FI); Jarmo PROKKOLA, Oulu (FI); Jouko SANKALA, Oulu (FI); Markus AHOKANGAS, Ylivieska (FI)

Correspondence Address: YOUNG & THOMPSON, 209 Madison Street, Suite 500, Alexandria, VA, 22314, US

(73) Assignee: VALTION TEKNILLINEN TUTKIMUSKESKU, Espoo (FI)

(21) Appl. No.: 12/274,406

(22) Filed: Nov. 20, 2008

(51) Int. Cl. G06F 15/173

(52) U.S. Cl. 709/224

(57) ABSTRACT

A method, apparatus, system, and computer program for analyzing properties of an application-specific end-to-end communication connection are presented. In a connection performance analysis apparatus, measurement data messages are received from a plurality of traffic-monitoring nodes arranged at selected intermediate points in a plurality of network segments of the application-specific end-to-end communication connection and from at least one end node of the end-to-end communication connection, wherein a measurement data message comprises information related to a travel time of at least one data packet of the end-to-end communication connection to the traffic-monitoring node or to the end node transmitting the respective measurement data message. Then, the connection performance analysis apparatus analyzes the received measurement data messages in order to determine a bottleneck of the end-to-end communication connection.

### FIELD

The invention relates to the field of communication networks and, particularly, to monitoring performance of an end-to-end connection.

### BACKGROUND

In network traffic monitoring, measurement data is collected from traffic flows, and the measurement data is analyzed in order to get insight into the state of the networks and connections in the networks. Such traffic monitoring may be conducted in order to help performance management of the network, to track changes in topology and/or routing of traffic in the network and tracing security attacks.

Network traffic monitoring methods may be divided into active and passive methods. In an active method, artificial traffic is generated, and the flow of the artificial traffic is monitored in the network, while passive methods monitor traffic generated to the network by real applications. In other words, passive methods do not cause interference and additional traffic in the network.

Network traffic monitoring is typically carried out at a single point or node of the network or in a single network segment in order to determine the performance of the node or network segment under study. This gives, however, very limited information on the performance of an end-to-end connection of a given application, because the end-to-end connection is typically routed through a plurality of network segments. On the other hand, end-to-end performance of the connection may be determined, for example, by pinging. Pinging may be used to determine a round-trip-time of the end-to-end connection, but it does not provide any information on the performance of individual network segments through which the end-to-end connection is routed. Additionally, pinging is an active method, which is not related to any real application, and it gives only round-trip performance information, while for real-time applications, for example, it is expressly the one-way performance information which matters. Therefore, improvement in the network traffic monitoring schemes is needed.

### BRIEF DESCRIPTION

An object of the present invention is to provide an improved method, apparatus, network, and computer program embodied on a computer-readable distribution medium to enable real-time multipoint passive measurement of application data packets and detection of bottlenecks in an application-specific end-to-end communication connection.

According to an aspect of the present invention, there is provided a method for passively monitoring network traffic. The method comprises transferring data packets between end-points of an application-specific end-to-end communication connection through a plurality of network segments. The method further comprises receiving, in a connection performance analysis apparatus, measurement data messages from a plurality of traffic-monitoring nodes arranged in selected intermediate points in the plurality of network segments of the end-to-end communication connection and from at least one end node of the end-to-end communication connection, wherein a measurement data message comprises information related to a travel time of at least one data packet of the end-to-end communication connection in the traffic-monitoring node or the end node transmitting the respective measurement data message, and analyzing, in the connection performance analysis apparatus, the received measurement data messages in order to determine a bottleneck of the end-to-end communication connection.

According to another aspect of the present invention, there is provided a connection performance analysis apparatus comprising an interface configured to receive measurement data messages from a plurality of traffic-monitoring nodes arranged in selected intermediate points in a plurality of network segments of an application-specific end-to-end communication connection and from at least one end node of the end-to-end communication connection, wherein a measurement data message comprises information related to a travel time of at least one data packet of the end-to-end communication connection to the traffic-monitoring node or to the end node transmitting the respective measurement data message. The apparatus further comprises a processing unit configured to analyze the received measurement data messages in order to determine a bottleneck of the end-to-end communication connection.

According to another aspect of the present invention, there is provided a system for passively monitoring network traffic, the system comprising a transmission end node of an application-specific end-to-end communication connection routed through a plurality of network segments, a reception end node configured to communicate with the transmission end node over the end-to-end communication connection, and a plurality of traffic-monitoring nodes arranged in selected intermediate points in the plurality of network segments of the end-to-end communication connection, wherein each of the plurality of traffic-monitoring nodes is configured to acquire information related to a travel time of at least one received data packet of the end-to-end communication connection, to create a measurement data message comprising the information related to the travel time of at least one received data packet, and to transmit the measurement data message to a connection performance analysis apparatus. The system further comprises the connection performance analysis apparatus comprising an interface configured to receive the measurement data messages from the plurality of traffic-monitoring nodes and from at least one of the transmission end node and the reception end node, wherein a measurement data message comprises information related to the travel time of at least one data packet of the end-to-end communication connection to the traffic-monitoring node or to the end node transmitting the respective measurement data message, and a processing unit configured to analyze the received measurement data messages in order to determine a bottleneck of the end-to-end communication connection.

According to another aspect of the present invention, there is provided a connection performance analysis apparatus, comprising means for receiving measurement data messages from a plurality of traffic-monitoring nodes arranged at selected intermediate points in a plurality of network segments of an application-specific end-to-end communication connection and from at least one end node of the end-to-end communication connection, wherein a measurement data message comprises information related to travel time of at least one data packet of the end-to-end communication connection to the traffic-monitoring node or to the end node transmitting the respective measurement data message, and means for analyzing, in the connection performance analysis apparatus, the received measurement data messages in order to determine a bottleneck of the end-to-end communication connection.

According to another aspect of the present invention, there is provided a traffic-monitoring apparatus arranged to be disposed in a network element along a path of at least one end-to-end communication connection, the apparatus comprising an interface configured to receive data packets transferred between a transmission end node and a reception end node of the at least one end-to-end communication connection, and a processing unit configured to time-stamp received data packets with at least one of a transmission time stamp and a reception time stamp, where the transmission time stamp indicates transmission timing of a data packet from the network node, and the reception time stamp indicates reception timing of the data packet in the network node, to create a measurement data message comprising information related to the time stamps, and to transmit the measurement data message to a connection performance analysis apparatus configured to monitor the performance of the end-to-end communication connection.

According to another aspect of the present invention, there is provided a computer program product embodied on a distribution medium readable by a computer and comprising program instructions which, when loaded into the computer, execute a computer process for analyzing properties of an application specific end-to-end communication connection comprising: receiving measurement data messages from a plurality of traffic-monitoring nodes arranged at selected intermediate points in a plurality of network segments of the application-specific end-to-end communication connection and from at least one end node of the end-to-end communication connection, wherein a measurement data message comprises information related to a travel time of at least one data packet of the end-to-end communication connection to the traffic-monitoring node or to the end node transmitting the respective measurement data message. The process further comprises analyzing the received measurement data messages in order to determine a bottleneck of the end-to-end communication connection.

Embodiments of the invention are defined in the dependent claims.

### LIST OF DRAWINGS

Embodiments of the present invention are described below, by way of example only, with reference to the accompanying drawings, in which

FIG. 1 illustrates an end-to-end communication connection between two units of user equipment;

FIG. 2 illustrates an arrangement for monitoring network traffic according to an embodiment of the invention;

FIG. 3 illustrates a format for a measurement data message according to an embodiment of the invention;

FIG. 4 illustrates an example of a structure of a connection performance analysis apparatus according to an embodiment of the invention;

FIG. 5 illustrates the arrangement for monitoring the network traffic by using layered illustration;

FIG. 6 is a flow diagram illustrating a process for processing a data packet to be transmitted in a transmitting end node of a connection according to an embodiment of the invention;

FIG. 7 is a flow diagram illustrating a process for monitoring network traffic in a traffic-monitoring node according to an embodiment of the invention; and

FIG. 8 is a flow diagram illustrating a process for analyzing received network traffic measurement data messages in the connection performance analysis apparatus according to an embodiment of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

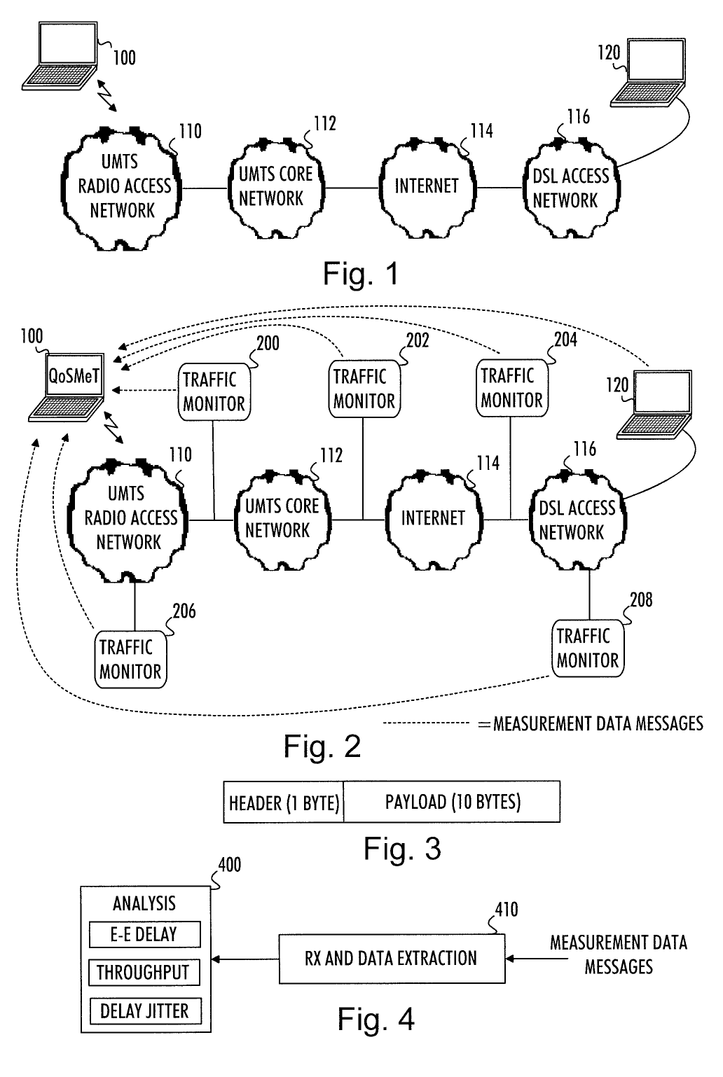

An example of a network structure for an end-to-end communication connection between two units of user equipment (UE) 100, 120 is illustrated in FIG. 1. The end-to-end connection may also be established between one UE and a server or between two servers. The end-to-end connection may be any type of application-specific communication connection, such as a voice connection, e.g. voice over Internet Protocol (VoIP), a download streaming connection, messaging connection, gaming connection, Internet browsing connection, etc. As known in the art, the UEs 100, 120 may be located far from each other, and the traffic related to the communication between the two units of user equipment 100, 120 may have to be routed via multiple network segments, e.g. via multiple separate Internet protocol networks. FIG. 1 illustrates exemplary network segments through which the end-to-end connection may be routed. In this example, the first UE 100 is a terminal device of a wireless mobile telecommunication system. In this example, the mobile telecommunication system is a Universal Mobile Telecommunication system (UMTS). Accordingly, the end-to-end connection is first routed through a radio access network 110 of the UMTS. From the radio access network 110 of the UMTS, the connection is routed through a core network 112 of the UMTS to the Internet 114. In this example a second UE 120 is a home computer connected to the Internet 114 through a Digital Subscriber Line (DSL). Accordingly, the end-to-end connection is routed from the Internet 114 to the second UE 120 through a DSL access network of a service provider of the DSL connection of the second UE 120. The UMTS radio access network 110, UMTS core network 112, the Internet 114, and a DSL access network 116 serve as examples of network segments through which the end-to-end connection may be routed. Further examples of such network segments include wired and wireless local area networks (LAN), any other type of wireless radio access networks, such as WIMAX (Worldwide Interoperability for Microwave Access) and GSM (Global System for Mobile communications), etc. In general, the network segments may be any type of networks through which the end-to-end communication connection may be routed in order to establish an end-to-end Internet protocol (IP) connection between two units of user equipment.

The UEs 100, 120 may be any type of communication devices provided with a capability to communicate with other communication devices over wired and/or wireless connections. The UEs 100, 120 may be personal computers, personal digital assistants (PDA), mobile phones, etc.

The behavior and performance of the network segments and properties of the end-to-end connection in different network segments is very unpredictable due to the dynamic nature of traffic in different network segments, different properties of radio environment in the radio access network, and different capabilities of individual components in the network chain, such as routers, gateways, and other network components but also the end devices (the UEs 100, 120). When considering a single end-to-end connection in a case where a full capacity, i.e. a full data rate, of the connection cannot be achieved, a single link, device, or network segment may very well cause a reduction in the data rate and, thereby, function as a bottleneck for the connection but also for other connections routed through the same bottleneck.

An object of the present invention is to detect bottlenecks in an end-to-end communication connection in order to improve the efficiency of the communication connection, network segments, and/or network chains. The object is achieved by providing a connection performance analysis apparatus configured to receive measurement data messages from a plurality of traffic-monitoring nodes arranged at selected intermediate points in a plurality of network segments of an application-specific end-to-end communication connection between two UEs. Additionally, the connection performance analysis apparatus is configured to receive the measurement data messages from at least one end node of the end-to-end communication connection, i.e. from at least one of the UEs.

A measurement data message comprises information on a travel time of at least one data packet of the end-to-end communication connection in the traffic-monitoring node or the end node transmitting the respective measurement data message. The information on the travel time of the data packet may include reception time of the data packet in the respective node or the actual travel time of the data packet from a source UE to the respective node. An embodiment in which measurement data packets carry the actual travel time (or delay) values is described in more detail below. The connection performance analysis apparatus then analyzes the received measurement data messages in order to determine a bottleneck of the end-to-end communication connection.

The embodiments of the invention provide a solution for monitoring the performance of one or more end-to-end connections passively and in real-time. In other words, the embodiments constantly provide information on the performance of the connection(s) without affecting or modifying the connection(s) or data packets transferred in the connection(s).

Let us describe an embodiment of the invention in greater detail with reference to FIG. 2. FIG. 2 illustrates the end-to-end communication connection between the first and second UE 100, 120 described above in connection with FIG. 1. The connection performance analysis apparatus is now provided in the first UE 100, but it should be noted that the connection performance analysis apparatus may also be provided in the second UE 120, in any traffic-monitoring node located at intermediate points of the connection, in another location having a communication connection to the UEs 100, 120 and to the traffic-monitoring nodes, or in a plurality of these locations. In practice, the connection performance analysis apparatus may be implemented by a processor controlled by a suitable network traffic analysis software module.

According to the embodiment of the invention, a plurality of traffic-monitoring nodes 200, 202, 204, 206, 208 may be provided at a plurality of intermediate points along the route of the end-to-end communication connection. The locations of the traffic-monitoring nodes 200 to 208 are selected beforehand such that they may be used to determine the performance of desired entities such as a given network segment, individual link, or chain of links, or individual network component, e.g. a router. In order to determine the performance of a network segment, a traffic-monitoring node may be located in gateway nodes at both ends of the network segment under study with respect to the end-to-end communication connection. Referring to FIG. 2, a first and second traffic-monitoring node 200 and 202 are located at two gateway nodes of the UMTS core network 112 in order to determine the performance of the UMTS core network 112. A gateway node in which the first traffic-monitoring node 200 is provided links the UMTS core network 112 to the UMTS radio access network 110, while a second gateway node in which the second traffic-monitoring node 202 is provided links the UMTS core network 112 to the Internet 114. Similarly, a third traffic-monitoring node 204 may be located at a gateway node linking the DSL access network 116 to the Internet 114 in order to determine the performance of the DSL access network 116 in conjunction with the second UE 120 also functioning as the traffic-monitoring nodes 200 to 208. A fourth traffic-monitoring node 206 may be located in the UMTS radio access network segment in order to determine the performance of a selected link or chain of links in the UMTS radio access network. The fourth traffic-monitoring node 206 may be located in an end-point of an asynchronous transfer mode (ATM) connection between a base station (Node B) and a radio network controller, for example. Similarly, a fifth traffic-monitoring node 208 may be located in the DSL access network 116 to determine the performance of a selected link in the DSL access network segment.

The traffic-monitoring nodes 200 to 208 at the intermediate points of the end-to-end connection and the end nodes of the connection, that is the UEs 100, 120, are configured to monitor and analyze the network traffic passively. In other words, neither the UEs 100, 120 nor the traffic-monitoring nodes 200 to 208 create artificial traffic, e.g. test packets, but monitor application-specific data packet flows and gather traffic information from the data packets flowing through the corresponding node.

According to an embodiment of the invention, the traffic-monitoring nodes and the UEs 120 are synchronized with each other. The synchronization may be carried out according to any method known in the art considered to provide sufficiently accurate time synchronization for the implementation of the embodiment. The synchronization may be performed, for example, with the Global Positioning System (GPS) or with a Precision Time Protocol (PTP).

Let us now consider measurement of a one-way delay according to an embodiment of the invention. Let us consider a case where the first UE 100 is a transmission end node, i.e. a source of data packets, and the second UE is a reception end node, i.e. a drain of the data packets, and the connection from the first UE 100 to the second UE 120, i.e. the uplink of the first UE 100 and the downlink of the second UE 120, is under study. The traffic-monitoring nodes 202 to 208 and the UEs 100, 120 are synchronized with each other, as described above. When the first UE 100 is about to transmit a data packet to the second UE 120 through the network segments 110 to 116, the connection performance analysis apparatus time-stamps the data packet with a transmission time stamp before the actual transmission of the data packet from the first UE 100 in order to obtain a transmission time for the data packet. The time-stamping may be understood as a procedure for acquiring transmission (or reception) timing for the data packet. In other words, the time-stamping may be performed without adding any time stamp to the data packets. The connection performance analysis apparatus then stores the transmission time stamp. Then, the data packet is transmitted from the first UE 100 to the UMTS radio access network 110, wherein the fourth traffic-monitoring node 206 captures the data packet. The fourth traffic-monitoring node 206 may acquire source and destination addresses of the data packet, an identifier of the data packet, and a packet size from header information of the data packet and time-stamp the data packet with a reception time stamp in order to obtain a reception time of the data packet and store the reception time stamp. Then, the data packet is forwarded towards its destination, i.e. towards the second UE 120.

Then, the fourth traffic-monitoring node 206 creates a measurement data message having a format illustrated in FIG. 3. A header of the measurement data message may comprise source and destination (Internet protocol, IP) addresses of the measurement data message. Alternatively, the header may comprise a protocol identifier, a flow identifier, such as IP sockets (source and destination) of the end-to-end connection, and/or any other indicator identifying the end-to-end connection in question. The length of the header may be one byte, as illustrated in FIG. 3, but it may be longer, depending on the implementation. A payload portion of the measurement data message may comprise a message identifier of the data packet and the reception time stamp. The message identifier of the data packet may be an IP sequence identifier, real-time transport protocol (RTP) identifier or a corresponding identifier, depending on the connection type of the end-to-end communication connection. The length of the payload portion may be ten bytes, as illustrated in FIG. 3, but the length of 10 bytes is merely exemplary, since the length is dependent on the implementation of the measurement data message. For example, if transmission time stamps of the data packet in question are also included in the measurement data message, the payload portion is naturally larger. Then, the fourth traffic-monitoring node transmits the measurement data message to the first UE 100 through the UMTS radio access network 110. As can be appreciated, the measurement data messages are typically small in comparison to the size of the actual data packets, which may have a size of up to dozens of kilobytes, so the measurement data messages cause negligible load to the network traffic.

Next, the data packet is captured by the first traffic-monitoring node 200 which performs the same functions as the fourth traffic-monitoring node 206, i.e. time-stamps the received data packet with a reception time stamp, acquires the identifiers from the data packet, forwards the data packet to the UMTS core network 112, creates a measurement data message including the reception time stamp generated by the first traffic-monitoring node 202, and transmits the measurement data message to the first UE 100. The rest of the traffic-monitoring nodes 202, 204, and 208 carry out the same procedure upon reception of the data packet. Furthermore, the second UE 120 also carries out this procedure in order to generate the actual reception time at the other end of the connection and to transmit the measurement data message comprising a reception time stamp including the reception time at the second UE 120 to the first UE 100.

Accordingly, the connection performance analysis apparatus included in the first UE 100 receives the measurement data messages from the traffic-monitoring nodes 200 to 208 and from the second UE 120 and, then, analyzes the received measurement data messages. Since the received measurement data messages comprise information on the arrival time of the data packet at each intermediate point associated with a given traffic-monitoring node and at the other end node of the connection, the connection performance analysis apparatus is capable of determining the travel time of the data packet between any pair of traffic-monitoring nodes and end nodes. Let us remind that the connection performance analysis apparatus stored the transmission time stamp at the transmission of the data packet. Accordingly, the connection performance analysis apparatus is able to determine an end-to-end delay of the data packet from the first UE 100 to the second UE 120 but also delays caused by different network segments 110 to 116. When this procedure is repeated on a plurality of data packets, the connection performance analysis apparatus is also able to calculate throughput, delay jitter, and other properties of the connection. Additionally, the network traffic analysis may calculate the number and/or ratio of lost packets in the connection. The connection performance analysis apparatus has information (reception time stamps) on the received packets of the tracked stream from all the traffic monitoring nodes, and may thus calculate packet loss for any of the network segments in addition to the end-to-end packet loss, without any extra information exchange between the measurement points. The connection performance analysis apparatus may detect the loss of a data packet when no measurement data message for the data packet is received from one or more traffic monitoring nodes. The connection performance analysis apparatus may wait for the reception of the measurement data message for the data packet for a given period of time after determining the packet loss. If no measurement data message is received from an intermediate traffic monitoring node but is received from the reception end node, or from any intermediate node following the node from which the measurement data message was not received, the connection performance analysis apparatus may determine that the packet was not lost, because it has been received by a later node. A user of the connection performance analysis apparatus is then able to deduce the bottleneck(s) of the whole connection, e.g. network segments and/or devices that cause the longest delays or greatest packet losses in the connection.

As mentioned above, the connection performance analysis apparatus may be implemented in both end nodes of the end-to-end connection. In such a case, each connection performance analysis apparatus may monitor one connection direction. For example, both connection performance analysis apparatuses may monitor their uplink direction such that a first connection performance analysis apparatus monitors a communication direction towards a second connection performance analysis apparatus, and the second connection performance analysis apparatus monitors a communication direction towards the first connection performance analysis apparatus. In this case, the operation of both connection performance analysis apparatuses may be as described above with reference to FIG. 2. If both connection performance analysis apparatuses are configured to monitor downlink directions, the measurement data messages may be sent to the receiving end node of the data packets. In this manner, each connection performance analysis apparatus may monitor its uplink and/or downlink directions.

The network structure between the end nodes 100, 120 of the communication connection may also include a private network such as one formed by a private router or a WLAN access point dedicated to serve only a limited number of users. Such a private network element may also comprise a traffic monitoring node which enables the connection performance analysis apparatus to determine whether or not the private network of the user is the bottleneck. If this is the case, modifications to the other (public) parts of the connection may be found unnecessary, and no resources are wasted to improve the performance of the network segments which do not constitute the bottleneck.

The connection performance analysis apparatus may naturally monitor the performance of a plurality of end-to-end connections simultaneously. The end-to-end connections may be formed between the same end nodes, or the end-to-end connections may be formed between the end node comprising the connection performance analysis apparatus and multiple different end nodes.

FIG. 4 illustrates a block diagram of the connection performance analysis apparatus according to an embodiment of the invention. The apparatus may comprise a reception and data extraction unit 410 which represents an embodiment of an interface for receiving the measurement data messages. The reception and data extraction unit 410 may be configured to extract payload data from the received measurement data message and, then, forward the payload data to an analysis unit 400. The reception and data extraction unit 410 may also provide the analysis unit 400 with information on an origin of each measurement data message. The analysis unit 400 may be configured to analyze the received payload data in order to calculate determined parameters of the connection. The analysis unit 400 may comprise analysis sub-units for computing the end-to-end delay, throughput, delay jitter, etc.

The above description focuses on describing the performance monitoring related to the uplink of the first UE 100. The downlink of the first UE 100 may be monitored by monitoring data packets transmitted by the second UE 120. Accordingly, the second UE 120 may be configured to time-stamp a data packet to be transmitted with a transmission time stamp and then transmit the data packet to the first UE over the end-to-end connection. Then, the second UE 120 may construct the measurement data message comprising the transmission time stamp and transmit the measurement data message to the first UE 100 including the connection performance analysis apparatus. The operation of the traffic-monitoring nodes 200 to 208 is similar to that described above, i.e. they acquire reception time stamps for the data packet received from the direction of the second UE 120 and transmit the reception time stamps to the first UE 100. The first UE 100 also time-stamps the received data packets with reception time stamps of the received data packets and provides the connection performance analysis apparatus with the reception time stamps. Then, the connection performance analysis apparatus may analyze the received measurement data messages and time stamps and determine properties of the downlink of the first UE 100.

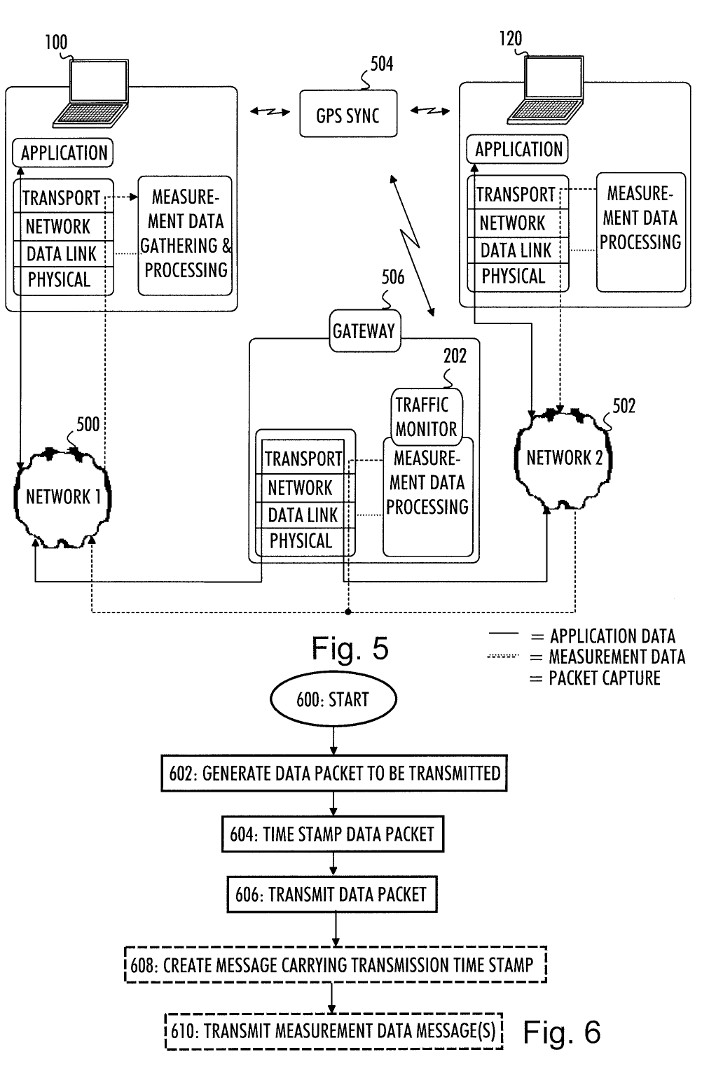

FIG. 5 illustrates a detailed procedure for collecting the measurement data from the data packets in each end node, i.e. the first and second UE 100, 120, and in a traffic-monitoring node 202 located along a route of the end-to-end connection. In this example, the traffic-monitoring node 202 is the second traffic-monitoring node 202 illustrated in FIG. 2 and located in a gateway node 506 linking the UMTS core network 112 to the Internet 114. The nodes 100, 120, and 202 monitoring and time-stamping the data packets are synchronized with each other through GPS 504, for example.

Let us consider the uplink of the first UE 100 as described above. An application executed in the first UE 100 needs to transmit data to the second UE and, as a consequence, generates data in an application layer. Then, the generated data is processed in a transport layer and network layer according to a method known in the art according to the connection type of the end-to-end connection between the UEs 100, 120. In a data link layer of the first UE 100, a data packet to be transmitted to the second UE 120 and comprising data generated by the application is captured and time-stamped with a transmission time stamp. Then, the transmission time stamp is stored in a memory unit of the first UE 100 and the data packet is transmitted to the second UE 120 through a physical layer of the first UE 100 towards the second UE 120. The data packet is first transferred through a first network 500, which in this example comprises the UMTS radio access network 110 and the UMTS core network 112. Then, the data packet is received by the gateway node 500 which receives the data packet in the physical layer, and it may process the received data packet in the data link, network, and transport layers in order to determine routing parameters for the data packet. The traffic-monitoring node 202 may be configured to capture the data packet on the data link layer when the data packet is received from the physical layer and to time-stamp the received data packet with the reception time stamp. Then, the data packet is forwarded to the network layer.

Additionally, the traffic-monitoring node 202 may be configured to capture the data packet again before transmission of the data packet from the gateway. When the data packet is received in the data link layer from the network layer, the traffic-monitoring node 202 may again capture the data packet and time-stamp the data packet with a transmission time stamp to obtain a transmission time for the data packet. Then, the data packet may be conveyed to the physical layer and transmitted from the gateway node 506 to a second network 502. The traffic-monitoring node 202 may be configured to create the measurement data message comprising the reception and transmission time stamps and the identifier of the data packet and to transmit the measurement data message to the first UE 100. Accordingly, the measurement data message may be arranged to comprise both reception and transmission time stamps, or the reception time stamp and the transmission time stamp may be transmitted in separate measurement data messages. In the latter case, the measurement data message may comprise a time stamp indicator indicating the type of the time stamp, i.e. whether the time stamp included in the message is a reception time stamp or a transmission time stamp. The format of the measurement data message illustrated in FIG. 3 may be modified to support both reception and transmission time stamps. The created measurement data message is transmitted through the transport, network, data link, and physical layers of the gateway node to the first UE 100. The measurement data messages may be bundled into a container type message, which includes information on several transmitted and/or received packets. In an embodiment, information (identifier and time stamp(s)) on the received and/or transmitted packets is recorded for a determined period of time, e.g. one second, after which the measurement data messages are sent to the connection performance analysis apparatus in a single measurement (TCP or UDP) packet. This improves the utilization of network resources.

When the traffic-monitoring node 202 time-stamps a data packet with both reception and transmission time stamps, the connection performance analysis apparatus is capable of calculating a delay caused by the gateway node 506. Together with the transmission and reception time stamps acquired from the nodes 100, 120, it is possible to determine whether the gateway node itself is the bottleneck of the end-to-end connection, thereby further improving the resolution of the procedure for determining the performance of the end-to-end communication connection.

In this example, the second network 502 comprises the Internet 114 and the DSL access network 116, through which the data packet is routed to the second UE 120. In the second UE 120, the received data packet is first processed in the physical layer from which it is conveyed to the data link layer. In the data link layer, the received data packet is captured and time-stamped with a reception time stamp. Then, the data packet is forwarded to the application layer of the second UE 120 through the network and transport layers. The second UE 120 also creates the measurement data message comprising the reception time stamp of the data packet and the identifier of the data packet. The measurement data message may be transmitted to the first UE 100 through the transport, network, data link, and physical layers of the second UE 120.

In a similar manner, when a data packet is transmitted from the application layer of the second UE 120 to the application layer of the first UE 100, the data packet is conveyed through the application, transport, network, data link, and physical layers of the second UE 120, wherein the second UE 120 is configured to capture the data packet in the data link layer and to time-stamp the data packet with a transmission time stamp. Then, the data packet is transferred to the gateway node 506 through the second network 502. The second UE 120 also creates the measurement data message comprising the transmission time stamp and the identifier of the data packet and transmits the measurement data message to the first UE 100.

The operation of the gateway node 506 is similar to that described above. In other words, the traffic-monitoring node 202 comprised in the gateway node 506 receives the data packet originating from the second UE 120 through the second network 502, captures the data packet on the data link layer, and time-stamps the data packet with a reception time stamp. Then, the data packet is forwarded to the network and transport layers and again transmitted towards the first UE 100. In transmission, the data packet may again be captured in the data link layer and time-stamped with a transmission time stamp, as described above. Then, the traffic-monitoring node 202 may create the measurement data message comprising the transmission and/or reception time stamp and transmit the measurement data message to the first UE.

The first UE 100 receives the data packet and captures it on the data link layer in order to time-stamp the data packet with the reception time stamp to enable the connection performance analysis apparatus to determine the delays and other properties of the two-way connection.

The traffic-monitoring nodes may be implemented by software modules at selected intermediate points of the end-to-end connection and in the end nodes of the connection. The traffic-monitoring nodes may be configured to transmit the measurement data messages to a predetermined (IP) address. The traffic-monitoring node may be implemented even in a regular home computer of a conventional user. The connection performance analysis apparatus may be implemented in one end of the end-to-end connection, as described above, at any intermediate point of the connection, or in any other location from which it is capable of establishing a communication connection to the end nodes of the end-to-end connection and to the traffic-monitoring nodes at the intermediate points of the connection. In the latter cases, the connection performance analysis apparatus may configure both end nodes to time-stamp transmission data packets with transmission time stamps and to transmit the transmission time stamps to the connection performance analysis apparatus. The reception time stamps are naturally also transmitted to the connection performance analysis apparatus. The traffic-monitoring nodes are configured to analyze only header information of the data packet, i.e. there is no need to process the actual payload application data. This is preferable for security reasons.

In an alternative embodiment, each traffic-monitoring node is provided with information on the transmission time of each data packet, and the traffic-monitoring nodes calculate delays on the basis of received transmission times and reception time stamps acquired for received data packets. Accordingly, the traffic-monitoring nodes need the transmission time of the data packet. The transmitting end node transmitting a data packet may send the transmission time stamp to the traffic-monitoring nodes in a message having a suitable format. The message may have a format similar to that illustrated in FIG. 3 but also comprise an indicator to indicate that the message comprises a transmission time stamp. This scheme may, however, be inefficient when considering the load caused to the networks, because the same message is transmitted to multiple intermediate nodes. Therefore, in an embodiment of the invention, the transmitting end node is configured to transmit the transmission time stamp associated with the transmitted data packet to the receiving end node. The traffic-monitoring nodes located along the path of the connection are configured to detect the messages carrying the transmission time stamps and to capture and read the transmission time stamp from the detected messages. Then, the traffic-monitoring nodes forward the message towards the receiving end node without modifying the message. In other words, the intermediate traffic monitoring nodes also monitor the measurement control traffic in addition to the monitored application data stream, and thus are able to passively acquire enough information for calculating the desired connection performance metrics.

Referring to FIG. 5, if the first UE 100 is transmitting a data packet and time-stamps the data packet with the transmission time stamp, the first UE 100 may be configured to transmit the transmission time stamp and the identifier of the data packet to the second UE 120 through the traffic-monitoring node 202. Upon reception of the data packet in the traffic-monitoring node 202, the data packet is time-stamped with a reception time stamp. Additionally, the traffic-monitoring node 202 is configured to capture a message carrying the transmission time stamp and acquire the transmission time stamp from the message. Then, the traffic-monitoring node 202 is configured to calculate a time difference between the received transmission time stamp and the reception time stamp. Then, the traffic-monitoring node 202 may create the measurement data message comprising the calculated time difference and the identifier of the data packet and to transmit the measurement data message to the first UE 100. Naturally, the measurement data messages may be bundled also in this embodiment. In a further modification of this embodiment, the traffic-monitoring node 202 may average time differences calculated for a plurality of received data packets and to transmit to the first UE 100 an average value of time differences associated with data packets received through the same end-to-end communication connection. The averaging reduces signaling overhead caused by transmission of the measurement data messages. The second UE 120 may carry out the same procedure for the data packet. Accordingly, the connection performance analysis apparatus receives directly delay values from different nodes of the end-to-end connection, wherein the delay values indicate a travel time of the data packet from the first UE 100 to the corresponding node.

The identifier of the data packet may also be omitted in this embodiment, i.e. the traffic-monitoring nodes may transmit to the connection performance analysis apparatus only the calculated delay values, and the connection performance analysis apparatus may calculate delays in different network segments and in the whole end-to-end connection from the delay values. This provides limited information on the performance of the connection, but it generates only marginal network traffic due to the reduced amount of transmitted measurement information. In order to provide more detailed information for the calculation of packet losses, for example, the traffic-monitoring nodes may be configured to send the delay values together with association to a corresponding data packet. A switch between these operational modes may be carried out on the fly with a command sent from the connection performance analysis apparatus to the traffic-monitoring nodes. In an exemplary scenario, an operator may first monitor connections in the limited mode which provides information on the delays in segments of the connection. Upon detection of increased delays or other undesired phenomena in the connection, the operator may switch to the detailed mode and, as a consequence, the operator gets more detailed information on the performance in the segments of the connection.

Next, let us consider a process for processing a data packet to be transmitted in a transmitting end node of an application-specific end-to-end communication connection with reference to FIG. 6. The end node is synchronized with other traffic-monitoring nodes disposed along the connection by GPS or by any other synchronization means. The process starts in block 600. In block 602, an application requesting transfer of data over a communication network generates a data packet for transmission. In block 604, the data packet is time-stamped with a transmission time stamp in order to acquire a transmission time for the data packet generated in block 602. The transmission time stamp may be acquired on a data link layer of the end node. The transmission time stamp is then stored for later use. The data packet is then transmitted towards the other end node of the end-to-end communication connection in block 606.

In block 608, a measurement data message is created, and the measurement data message is arranged to comprise the transmission time stamp(s) acquired in block 604 and an identifier(s) of the data packet(s). The identifier may be an IP sequence number, and RTP identifier, or any other identifier of the data packet depending on the connection type of the end-to-end connection. In block 610, the measurement data message is transmitted to the connection performance analysis apparatus connected to the same structure of networks as the end node, i.e. the end node is capable of communicating with the connection performance analysis apparatus. As described above, also messages carrying the transmission time stamps may be grouped together and transmitted as a bundle. Therefore, steps 602 and 604 may be repeated until a sufficient number of messages has been accumulated or a determined time interval has elapsed. Blocks 608 and 610 are optional, because if the connection performance analysis apparatus is included in the transmitting end node, blocks 608 and 610 may be omitted.

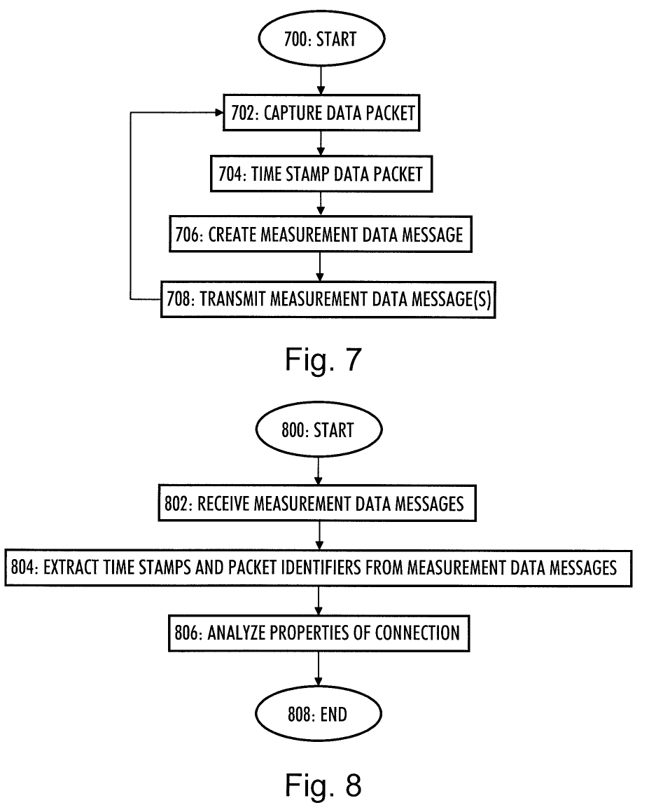

Next, a process for monitoring network traffic in the traffic-monitoring node according to an embodiment of the invention is described with reference to a flow diagram of FIG. 7. The process starts in block 700. In block 702, a data packet is received and captured. In block 704, the received data packet is time-stamped with a reception time stamp and/or a transmission time stamp. The reception time stamp may be acquired in the data link layer when the data packet is received, and the transmission time stamp may be acquired in the data link layer when the data packet is being transmitted from the traffic-monitoring node. Blocks 702 and 704 may be performed for a plurality of data packets before executing block 706.

In block 706, the traffic-monitoring node creates a measurement data message comprising transmission time stamps and/or reception time stamps acquired for a group of data packets in block 704, the identifier(s) of the data packet(s), and header information necessary for transmitting the measurement data message over a network structure to the connection performance analysis apparatus connected to the network structure. The traffic-monitoring node transmits the measurement data message to the connection performance analysis apparatus in block 708.

The traffic-monitoring node may be configured beforehand to limit the monitoring to selected end-to-end connections to reduce the amount of processing and transfer of measurement data messages in the network and in the connection performance analysis apparatus. It may not be feasible for the traffic-monitoring node to monitor and time-stamp every data packet of every connection routed through a network element including the traffic-monitoring node. Monitoring a single or a few selected connections typically provides sufficient information on the properties of the connections and the performance of network segments and individual components in the network segments.

Next, let us consider a process for analyzing received network traffic measurement data messages in the connection performance analysis apparatus according to an embodiment of the invention with reference to FIG. 8. The process starts in block 800. In block 802, the connection performance analysis apparatus receives a plurality of measurement data messages from traffic-monitoring nodes of a given end-to-end communication connection between two units of user equipment. The measurement data messages may be related to a plurality of data packets transferred between the two UEs and may comprise information on reception and/or transmission times of the data packets in the traffic-monitoring nodes located at selected intermediate points along the route of the end-to-end connection.

In block 804, the information on the transmission and/or reception times, e.g. time stamps or direct delay values, and identifiers of the data packets are extracted from the received measurement data messages. In block 806, the properties of the end-to-end connection are analyzed from the extracted time stamps and packet identifiers. Such analyzed properties may include at least one of the following: delay, delay jitter, round-trip delay, packet loss, connection break length, offered load, and throughput. All of these metrics may be calculated between any of the traffic monitoring points (including the end nodes) in the analyzed network path. These properties may then be displayed to the user of the connection performance analysis apparatus through a user interface, or the connection performance analysis apparatus may compare the properties to expected or allowed properties of the connection in order to identify a bottleneck of the connection. The process ends in block 808.

As mentioned above, the processes or methods described in FIGS. 6 to 8 may also be carried out in the form of a computer process defined by a computer program. The computer program may be in source code form, object code form, or in some intermediate form, and it may be stored on some sort of carrier, which may be any entity or device capable of carrying the program. Such carriers include a record medium, computer memory, read-only memory, and software distribution package, for example. Depending on the processing power needed, the computer program may be executed in a single electronic digital processing unit or it may be distributed amongst a number of processing units.

The present invention is applicable to telecommunication networks defined above but also to other suitable telecommunication networks. The networks may include network segments having a fixed infrastructure providing wired connections between elements of the network segment, network segments providing purely wireless connections, and network segments providing both wired and wireless connections.

It will be obvious to a person skilled in the art that, as technology advances, the inventive concept can be implemented in various ways. The invention and its embodiments are not limited to the examples described above but may vary within the scope of the claims.

1. A method for passively monitoring network traffic, comprising:
transferring data packets between end-points of an application-specific end-to-end communication connection through a plurality of network segments;
receiving, in a connection performance analysis apparatus, measurement data messages from a plurality of traffic-monitoring nodes arranged in selected intermediate points in the plurality of network segments of the end-to-end communication connection and from at least one end node of the end-to-end communication connection, wherein a measurement data message comprises information related to a travel time of at least one data packet of the end-to-end communication connection in the traffic-monitoring node or the end node transmitting the respective measurement data message; and
analyzing, in the connection performance analysis apparatus, the received measurement data messages in order to determine a bottleneck of the end-to-end communication connection.

2. The method of claim 1, wherein the plurality of traffic-monitoring nodes and the at least one end node are synchronized with each other, the method further comprising:
time-stamping a data packet in a transmission end node of the end-to-end communication connection with a transmission time stamp;
capturing and time-stamping the data packet in the plurality of traffic-monitoring nodes and a reception end node of the end-to-end communication connection with a reception time stamp upon reception of the data packet;
communicating the transmission time stamp and the plurality of reception time stamps to the connection performance analysis apparatus, wherein an identifier of the data packet is communicated together with the transmission time stamp and each of the plurality of reception time stamps; and
utilizing, in the connection performance analysis apparatus, the received transmission time stamp and the plurality of reception time stamps when determining the bottleneck of the end-to-end communication connection.

3. The method of claim 2, further comprising:
capturing and time-stamping the data packet in the plurality of traffic-monitoring nodes of the end-to-end communication connection with a transmission time stamp before transmitting the data packet towards the reception end node;
communicating the plurality of transmission time stamps to the connection performance analysis apparatus, wherein an identifier of the data packet is communicated together with each of the plurality of transmission time stamps; and
utilizing, in the connection performance analysis apparatus, the received plurality of transmission time stamps when determining the bottleneck of the end-to-end communication connection.

4. The method of claim 1, further comprising: locating at least some of the traffic-monitoring nodes in at least one gateway between the plurality of network segments of the end-to-end communication connection.

5. The method of claim 1, further comprising:
receiving, in the connection performance analysis apparatus, measurement data messages related to a plurality of data packets;
analyzing the received measurement data messages so as to calculate at least one quality-of-service metric.

6. The method of claim 5, wherein the at least one quality-of-service metric comprises at least one of the following parameters for one or more network segments of the end-to-end connection: delay, delay jitter, round-trip delay, number of lost packets ratio of lost packets, connection break length, offered load, and throughput.

7. The method of claim 1, further comprising:
time-stamping a data packet in a transmission end node of the end-to-end communication connection with a transmission time stamp;
communicating the transmission time stamp to the plurality of traffic-monitoring nodes and a reception end node of the end-to-end communication connection;
time-stamping the data packet in the plurality of traffic-monitoring nodes and a reception end node of the end-to-end communication connection with a reception time stamp;
calculating, in each of the plurality of traffic-monitoring nodes and the reception end node, a delay between the received transmission time stamp and the reception time stamp of the corresponding node; and
communicating, by each of the plurality of traffic-monitoring nodes and the reception end node, the calculated delay to the connection performance analysis apparatus as at least part of the measurement data.

8. The method of claim 7, further comprising:
transmitting the transmission time stamp from the transmitting end node in a message destined to the reception end node; and
detecting the message destined to the reception end node and comprising the transmission time stamp in each intermediate traffic-monitoring node; and
capturing the detected message and acquiring the transmission time stamp from the message in each intermediate traffic-monitoring node.

9. The method of claim 7, further comprising:
calculating a delay for a plurality of data packets in each of the plurality of traffic-monitoring nodes and the reception end node;
averaging, in each of the plurality of traffic-monitoring nodes and the reception end node, the calculated delays; and
communicating, by each of the plurality of traffic-monitoring nodes and the reception end node, the calculated average delay to the connection performance analysis apparatus as the measurement data.

10. The method of claim 1, wherein a measurement data packet comprises: a header comprising transport information on at least a source and destination of the measurement data packet; and a payload portion comprising information on the travel time of a data packet and an identifier of the data packet.

11. The method of claim 1, wherein the end-to-end communication connection comprises a plurality of Internet protocol networks as network segments.

12. A connection performance analysis apparatus comprising:
an interface configured to receive measurement data messages from a plurality of traffic-monitoring nodes arranged in selected intermediate points in a plurality of network segments of an application-specific end-to-end communication connection and from at least one end node of the end-to-end communication connection, wherein a measurement data message comprises information related to a travel time of at least one data packet of the end-to-end communication connection to the traffic-monitoring node or to the end node transmitting the respective measurement data message; and
a processing unit configured to analyze the received measurement data messages in order to determine a bottleneck of the end-to-end communication connection.

13. The apparatus of claim 12, wherein the interface is further configured to receive a transmission time stamp from a transmission end node transmitting a data packet, a plurality of reception time stamps related to the data packet from the plurality of traffic-monitoring nodes synchronized with each other and with the transmission end node, and an identifier of the data packet in connection with each time stamp, and wherein the processing unit is further configured to utilize the received transmission time stamp and the plurality of reception time stamps when determining the bottleneck of the end-to-end communication connection.

14. The apparatus of claim 13, wherein the interface is further configured to receive a plurality of transmission time stamps from the plurality of traffic-monitoring nodes and the identifier of the data packet in connection with each transmission time stamp, wherein each transmission time stamp indicates a transmission time of the data packet in a respective traffic-monitoring node, and wherein the processing unit is configured to utilize the received plurality of transmission time stamps when determining the bottleneck of the end-to-end communication connection.

15. The apparatus of claim 12, wherein the interface is further configured to receive measurement data messages related to a plurality of data packets, and the processing unit is further configured to analyze the received measurement data messages related to the plurality of data packets so as to calculate at least one quality-of-service metric.

16. The apparatus of claim 15, wherein the at least one quality-of-service metric comprises at least one of the following parameters for one or more network segments of the end-to-end connection: delay, delay jitter, round-trip delay, number of lost packets, ratio of lost packets, connection break length, offered load, and throughput.

17. The apparatus of claim 12, wherein the interface is further configured to receive a delay value related to a data packet from each traffic-monitoring node, wherein the delay value indicates the travel time of the data packet between two nodes of the end-to-end communication connection, and the processing unit is configured to analyze the received delay values in order to determine a bottleneck of the end-to-end communication connection.

18. The apparatus of claim 17, wherein the delay value indicates the travel time of the data packet between a transmission end node of the end-to-end communication connection and the traffic-monitoring node from which the delay value is received.

19. The apparatus of claim 12, wherein the interface is further configured to receive an average delay value related to a plurality of data packets from each traffic-monitoring node, wherein the delay value indicates an average travel time of a data packet between two nodes of the end-to-end communication connection, and the processing unit is configured to analyze the received average delay values in order to determine a bottleneck of the end-to-end communication connection.

20. The apparatus of claim 12, wherein a measurement data packet comprises: a header comprising transport information on at least a source and destination of the measurement data packet; and a payload portion comprising information on the travel time of a data packet and an identifier of the data packet.

21. The apparatus of claim 12, wherein the end-to-end communication connection comprises a plurality of Internet protocol networks as network segments.

22. A system for passively monitoring network traffic, the system comprising:
a transmission end node of an application-specific end-to-end communication connection routed through a plurality of network segments;
a reception end node configured to communicate with the transmission end node over the end-to-end communication connection;
a plurality of traffic-monitoring nodes arranged at selected intermediate points in the plurality of network segments of the end-to-end communication connection, wherein each of the plurality of traffic-monitoring nodes is configured to acquire information related to a travel time of at least one received data packet of the end-to-end communication connection, to create a measurement data message comprising the information related to the travel time of at least one received data packet, and to transmit the measurement data message to a connection performance analysis apparatus; and
the connection performance analysis apparatus comprising an interface configured to receive the measurement data messages from the plurality of traffic-monitoring nodes and from at least one of the transmission end node and the reception end node, wherein a measurement data message comprises information related to the travel time of at least one data packet of the end-to-end communication connection to the traffic-monitoring node or to the end node transmitting the respective measurement data message, and a processing unit configured to analyze the received measurement data messages in order to determine a bottleneck of the end-to-end communication connection.

23. The system of claim 22, wherein the plurality of traffic-monitoring nodes, the transmission end node, and the reception end node are synchronized with each other, wherein the transmission end node is configured to time-stamp a data packet to be transmitted with a transmission time stamp and to communicate the transmission time stamp to the connection performance analysis apparatus, wherein the traffic-monitoring nodes and the reception end node are configured to capture and time-stamp the data packet with a reception time stamp upon reception of the data packet and to communicate the reception time stamp to the connection performance analysis apparatus, wherein an identifier of the data packet is communicated together with the transmission time stamp and each of the plurality of reception time stamps, and wherein the connection performance analysis apparatus is configured to utilize the received transmission time stamp and the plurality of reception time stamps when determining the bottleneck of the end-to-end communication connection.

24. The system of claim 23, wherein the plurality of traffic-monitoring nodes are configured to capture and time-stamp the data packet with a transmission time stamp before transmitting the data packet towards the reception end node and to communicate the plurality of transmission time stamps to the connection performance analysis apparatus, wherein an identifier of the data packet is communicated together with each of the plurality of transmission time stamps, and wherein the connection performance analysis apparatus is configured to utilize the received plurality of transmission time stamps when determining the bottleneck of the end-to-end communication connection.

25. The system of claim 22, wherein at least some of the traffic-monitoring nodes is located in at least one gateway between the plurality of network segments of the end-to-end communication connection.

26. The system of claim 22, wherein the transmission end node is configured to time-stamp a data packet to be transmitted with a transmission time stamp and to communicate the transmission time stamp to the plurality of traffic-monitoring nodes and the reception end node, wherein the traffic-monitoring nodes and the reception end node are configured to time-stamp the data packet with a reception time stamp upon reception of the data packet and to calculate a delay between the received transmission time stamp and the reception time stamp, and to communicate the calculated delay to the connection performance analysis apparatus as at least part of the measurement data, and wherein the connection performance analysis apparatus is further configured to analyze the received delay values in order to determine a bottleneck of the end-to-end communication connection.

27. The system of claim 26, wherein:
the transmitting end node is configured to transmit the transmission time stamp in a message destined to the reception end node; and
each intermediate traffic-monitoring node is configured to detect the message destined to the reception end node and comprising the transmission time stamp, to capture the detected message, and to acquire the transmission time stamp from the message in each intermediate traffic-monitoring node.

28. The system of claim 26, wherein the transmission end node is configured to time-stamp a plurality of data packets with a transmission time stamp and to communicate the transmission time stamps to the plurality of traffic-monitoring nodes and the reception end node, wherein the plurality of traffic-monitoring nodes and the reception end node are configured to calculate a delay for a plurality of received data packets, to average the calculated delays, and to communicate the calculated average delays to the connection performance analysis apparatus as at least part of the measurement data, and wherein the connection performance analysis apparatus is configured to analyze the received average delay values in order to determine a bottleneck of the end-to-end communication connection.

29. A connection performance analysis apparatus, comprising:
means for receiving measurement data messages from a plurality of traffic-monitoring nodes arranged at selected intermediate points in a plurality of network segments of an application-specific end-to-end communication connection and from at least one end node of the end-to-end communication connection, wherein a measurement data message comprises information related to a travel time of at least one data packet of the end-to-end communication connection to the traffic-monitoring node or to the end node transmitting the respective measurement data message; and
means for analyzing, in the connection performance analysis apparatus, the received measurement data messages in order to determine a bottleneck of the end-to-end communication connection.

30. A traffic-monitoring apparatus arranged to be disposed in a network element along a path of at least one end-to-end communication connection comprising:
an interface configured to receive data packets transferred between a transmission end node and a reception end node of the at least one end-to-end communication connection; and
a processing unit configured to time-stamp received data packets with at least one of a transmission time stamp and a reception time stamp, where the transmission time stamp indicates transmission timing of a data packet from the network node, and the reception time stamp indicates reception timing of the data packet in the network node, to create a measurement data message comprising information related to the time stamps, and to transmit the measurement data message to a connection performance analysis apparatus configured to monitor the performance of the end-to-end communication connection.

31. The traffic-monitoring apparatus of claim 30, wherein the interface is further configured to receive a transmission time-stamp of a data packet from a transmitting end node of the end-to-end communication connection, and the processing unit is configured to time-stamp the data packet with a reception time stamp upon reception of the data packet, to calculate a delay between the received transmission time stamp and the reception time stamp, and to communicate the calculated delay to the connection performance analysis apparatus as at least a part of the measurement data message.

32. The traffic-monitoring apparatus of claim 31, wherein the processing unit is configured to detect a message comprising the transmission time stamp, wherein the message is destined to a reception end node of the end-to-end communication connection, to capture the detected message, and to acquire the transmission time stamp from the message.

33. A computer program product embodied on a distribution medium readable by a computer and comprising program instructions which, when loaded into the computer, execute a computer process for analyzing properties of an application specific end-to-end communication connection comprising:
receiving measurement data messages from a plurality of traffic-monitoring nodes arranged at selected intermediate points in a plurality of network segments of the application-specific end-to-end communication connection and from at least one end node of the end-to-end communication connection, wherein a measurement data message comprises information related to a travel time of at least one data packet of the end-to-end communication connection to the traffic-monitoring node or to the end node transmitting the respective measurement data message; and
analyzing the received measurement data messages in order to determine a bottleneck of the end-to-end communication connection.
